(19) United States
(12) Patent Application Publication
(10) Pub. No.: US 2008/0197283 A1
(43) Pub. Date: Aug. 21, 2008

(54) EMULSION AGGREGATION TONER COMPOSITIONS AND DEVELOPERS

(75) Inventors: Richard P.N. VEREGIN, Mississauga (CA); Eric M. STROHM, Burlington (CA); Eric ROTBERG, Toronto (CA); Michael S. HAWKINS, Cambridge (CA); Edward G. ZWARTZ, Mississauga (CA); Guerino G. SACRIPANTE, Oakville (CA)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/676,059

(22) Filed: Feb. 16, 2007

(51) Int. Cl. C09D 11/10; G03G 13/09

(52) U.S. Cl. 250/315.3; 106/31.25

(57) ABSTRACT

Disclosed herein are toner compositions and developers particularly suitable for use in xerographic devices having oil-less fuser systems. The disclosed toner composition is substantially free of crystalline resin.

### BACKGROUND

Disclosed herein are emulsion aggregation toner compositions and developers particularly suitable for use in xerographic devices having an oil-less fuser system. In particular, the emulsion aggregation toner is comprised of a polyester resin, and is substantially free of crystalline polyester resin.

### REFERENCES

In general, emulsion aggregation (EA) processes are known to fabricate toners. Emulsion polymerization typically comprises forming an emulsion of a surfactant and monomer in water, then polymerizing the monomer in the presence of a water soluble initiator. For example, U.S. Pat. No. 5,853,943, the disclosure of which is totally incorporated herein by reference in its entirety, is directed to a semi-continuous emulsion polymerization process for preparing a latex by first forming a seed polymer. U.S. Pat. No. 5,928,830, the disclosure of which is also totally incorporated herein by reference in its entirety, is directed to a semi-continuous emulsion polymerization process for preparing a latex preparation of a latex polymer with a core encapsulated within a shell polymer, wherein a toner prepared with said latex polymer exhibits good fix and gloss characteristics. The latex formed by emulsion polymerization is then aggregated to form toner particles.

EA toners produced by the above processes are generally ultrafine particle toners with precisely controlled particle size, size distribution, and particle shape. General EA processes for the preparation of toners are also illustrated in a number of Xerox patents, the disclosures of each of which are totally incorporated herein by reference, such as U.S. Pat. Nos. 5,290,654; 5,278,020; 5,308,734; 5,370,963; 5,344,738; 5,403,693; 5,418,108; 5,364,729; and 5,346,797.

For some applications in the graphics arts market, high gloss images are desired. For example, styrene/n-butyl acrylate EA toners are known. However, polyester toners capable of producing high gloss images are still desired. High gloss toners are especially useful for certain oil-less fusers, such as 80 page per minute (PPM) belt fuser fixtures that require high gloss images.

### SUMMARY

Described herein is an emulsion aggregation toner comprised of at least one polyester resin, wherein the toner is substantially free of crystalline resin, wherein the toner has an acid value of from 13 mg/eq. KOH to about 40 mg/eq. KOH, and wherein the toner has a toner cohesion of from about 0% to about 30% at about room temperature.

In further embodiments, described is an image forming device, comprising a development system including an emulsion aggregation toner, and an oil-less fuser member, wherein the emulsion aggregation toner is comprised of a polyester resin, is substantially free of a crystalline resin, and has a toner cohesion of from about 0% to about 30% at about room temperature.

In yet further embodiments, described is a process for forming particles, comprising generating an emulsion of a polyester resin having an acid value of from about 13 mg/eq. KOH to about 40 mg/eq. KOH, and generating aggregate particles from the emulsion, wherein the emulsion is substantially free of a crystalline polyester resin.

### EMBODIMENTS

Toners useful for xerographic applications should possess certain properties related to storage stability and particle size integrity. That is, it is desired to have the particles remain intact and not agglomerate until they are fused on paper. Since environmental conditions vary, the toners also should not substantially agglomerate up to a temperature of from about 50° C. to about 55° C. The toners described herein are particularly useful for use in xerographic devices having oil-less fusers.

The toner, comprised of at least resin and colorant, should also display acceptable triboelectrification properties, which vary with the type of carrier or developer composition. The toner may further provide improved toner cohesion, and improved gloss and crease area.

The toner should also possess low melting properties. That is, the toner may be a low melt or ultra low melt toner. Low melt toners display acceptable crease area after fusing at a temperature from about 150° C. to about 180° C., such as from about 150° C. to about 170° C., while ultra low melt toners display acceptable crease area after fusing at a temperature of from about 90° C. to about 150° C., such as from about 110° C. to about 140° C. Thus, the EA polyester toners disclosed herein display a melting point of from about 150° C. to 160° C. or from about 150° C. to about 170° C.

Additionally, small sized toner particles, such as from about 3 to about 15 microns, and for example from about 5 to about 12 microns, are desired, especially in xerographic engines wherein high resolution is required. Toners with the aforementioned small sizes can be economically prepared by chemical processes, also known as direct or “in situ” toner process, such as the emulsion aggregation process, or by suspension, microsuspension or microencapsulation processes.

Disclosed herein are emulsion aggregation toners, and processes for making emulsion aggregation toners, that exhibit one or more of the above desirable properties. The EA polyester toners are derived from at least one high acid amorphous polyester resin. That is, the starting polyester resin in the emulsion used to form aggregated toner particles has a high acid value. As a result, the EA polyester toner also has the high acid value. “High acid value” as used herein refers to, for example, an acid value of from about 13 mg/eq. KOH to about 40 mg/eq. KOH, for example, from about 20 mg/eq. KOH to about 35 mg/eq. KOH, or such as from about 20 mg/eq. KOH to about 25 mg/eq. KOH. The acid value is determined by titration method using potassium hydroxide as a neutralizing agent with a pH indicator.

As a result of such acid number value of the polyester in the initial emulsion, the use of surfactants in forming particles in the emulsion aggregation process may be omitted. This may be desirable where surfactants contribute to an end toner having reduced relative humidity (or RH) stability, particularly in the A-zone environment (28° C. and 85% relative humidity).

The polyester resin with a high acid number at a minimum permits the use of less surfactant in the emulsion compared to prior polyester resin emulsions with lower acid numbers, and thus promotes RH stability of the formed polyester particles, particularly in the A-zone. Typically, in conventional EA processes, the surfactant may be present in the toner in an amount from about 2 to about 3 percent by weight of the toner. The toner of the present application may contain surfactant in a range from about 0 to about 1 percent by weight of the toner. Desirably, the use of the high acid number polyester permits the use of surfactants to be eliminated.

The polyester resin with a high acid number thus allows for a toner that is substantially free of surfactant and/or coagulant. It is desirable for the toner that contains little or no surfactant so that washing of the toner can be minimized and removal of surfactants from water during recycling is easier. A toner with no coagulant is desirable for good A-zone charge.

The polyester resin may be synthesized to have high acid numbers, for example high carboxylic acid numbers. The polyester resin is made to have a high acid number by using an excess amount of diacid monomer over the diol monomer, or by using acid anhydrides to convert the hydroxl ends to acidic ends, for example by reaction of the polyester with known organic anhydrides such as trimellitic anhydride, phthalic anhydride, dodecyl succinic anhydride, maleic anhydride, 1,2,4,5-benzenedianhydride. 5-(2,5-dioxotetrahydrol)-3-methyl-3-cyclohexene-1,2-dicarboxylic anhydride, 5-(2,5-dioxotetrahydrol)-4-methyl-3-cyclohexene-1,2-dicarboxylic anhydride, pyromellitic dianhydride, benzophenone dianhydride. biphenyl dianhydride, bicyclo[2.2.2]-oct-7-ene tetracarboxylic acid dianhydride, cis,cis,cis,cis, 1,2,3,4-cyclopentane tetracarboxylic acid dianhydride, ethylenediamine tetracetic acid dianhydride, 4,4′-oxydiphthalic anhydride, 3,3′,4,4′-diphenylsulfone tetracarboxylic dianhydride, ethylene glycol bis-(anhydro-trimellitate), propylene glycol bis-(anhydro-trimellitate), diethylene glycol bis-(anhydro-trimellitate), dipropylene glycol bis-(anhydro-trimellitate), triethylene glycol bis-(anhydro-trimellitate), tripropylene glycol bis-(anhydro-trimellitate), tetraethylene glycol bis-(anhydro-trimellitate), glycerol bis-(anhydro-trimellitate), and mixtures thereof Allternatively the hydroxyl terminated polyester resin can be converted to hugh acid number polyester reins by reacting with multivalent polyacids, such as 1,2,4-benzene-tricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylene-carboxylpropane, tetra(methylene-carboxyl)methane, and 1,2,7,8-octanetetracarboxylic acid; acid anhydrides of multivalent polyacids; and lower alkyl esters of multivalent polyacids; multivalent polyols, such as sorbitol, 1,2,3,6-hexanetetrol, 1,4-sorbitane, pentaerythritol, dipentaerythritol, tripentaerythritol, sucrose, 1,2,4-butanetriol, 1,2,5-pentatriol, glycerol, 2-methylpropanetriol, 2-methyl-1,2,4-butanetriol, trimethylolethane, trimethylolpropane, 1,3,5-trihydroxymethylbenzene, mixtures thereof, and the like.

In embodiments, the polyester may be, for example poly(1,2-propylene-diethylene)terephthalate, polyethylene-terephthalate, polypropylene-terephthalate, polybutylene-terephthalate, polypentylene-terephthalate, polyhexalene-terephthalate, polyheptadene-terephthalate, polyoctalene-terephthalate, polyethylene-sebacate, polypropylene-sebacate, polybutylene-sebacate, polyethylene-adipate, polypropylene-adipate, polybutylene-adipate, polypentylene-adipate, polyhexalene-adipate polyheptadene-adipate, polyoctalene-adipate, polyethylene-glutarate, polypropylene-glutarate, polybutylene-glutarate, polypentylene-glutarate, polyhexalene-glutarate, polyheptadene-glutarate, polyoctalene-glutarate, polyethylene-pimelate, polypropylene-pimelate, polybutylene-pimelate, polypentylene-pimelate, polyhexalene-pimelate, polyheptadene-pimelate, poly(propoxylated bisphenol co-fumarate), poly(ethoxylated bisphenol co-fumarate), poly(butyloxylated bisphenol co-fumarate), poly(co-propoxylated bisphenol co ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co ethoxylated bisphenol co-itaconate), poly(1,2-propylene itaconate), or mixtures thereof

In embodiments, the polyester resin and resulting EA polyester toner each has a high acid number, in one embodiment, for example, from about 13 mg/eq. KOH to about 40 mg/eq. KOH, in another embodiment from about 20 mg/eq. KOH to about 35 mg/eq. KOH and in yet another embodiment from about 20 mg/eq. KOH to about 25 mg/eq. KOH.

The onset Tg (glass transition temperature) of the polyester resin, and the resulting EA-V polyester toner, may be from about 53° C., to about 70° C., such as from about 53° C. to about 67° C. or from about 56° C. to about 60° C. The Ts (softening temperature) of the polyester resin, and the resulting EA polyester toner, that is, the temperature at which the polyester resin, and the resulting EA polyester toner softens, may be from about 90° C. to about 135° C., such as from about 95° C. to about 130° C. or from about 105° C. to about 125° C.

In embodiments, the resin is an amorphous polyester. Examples of amorphous resins suitable for use herein include polyester resins, branched polyester resins and linear polyester resins.

The branched amorphous polyester resins are generally prepared by the polycondensation of an organic diol, a diacid or diester, and a multivalent polyacid or polyol as the branching agent and a polycondensation catalyst.

Examples of diacid or diesters selected for the preparation of amorphous polyesters include dicarboxylic acids or diesters selected from the group consisting of terephthalic acid, phthalic acid, isophthalic acid, fumaric acid, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and mixtures thereof. The organic diacid or diester are selected, for example, from about 45 to about 52 mole percent of the resin.

Examples of diols utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hyroxyethyl)-bisphenol A, bis(2-hyroxypropyl)-bisphenol A, 1,4-cyclohexanedimethanol, 1,3-cyclohexanedimethanol, xylenedimethanol, cyclohexanediol, diethylene glycol, bis(2-hydroxyethyl)oxide, dipropylene glycol, dibutylene, and mixtures thereof. The amount of organic diol selected can vary, and more specifically, is, for example, from about 45 to about 52 mole percent of the resin.

Branching agents to generate a branched amorphous polyester resin include, for example, a multivalent polyacid such as 1,2,4-benzene-tricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylene-carboxylpropane, tetra(methylene-carboxyl)methane, and 1,2,7,8-octanetetracarboxylic acid, acid anhydrides thereof, and lower alkyl esters thereof, 1 to about 6 carbon atoms; a multivalent polyol such as sorbitol, 1,2,3,6-hexanetetrol, 1,4-sorbitane, pentaerythritol, dipentaeythritol, tripentaerythritol, sucrose, 1,2,4-butanetriol, 1,2,5-pentatriol, glycerol, 2-methylpropanetriol, 2-methyl-1,2,4-butanetriol, trimethylolethane, trimethylolpropane, 1,3,5-trihydroxymethylbenzene, mixtures thereof, and the like. The branching agent amount selected is, for example, from about 0.1 to about 5 mole percent of the resin.

The amorphous resin may be, for example, present in an amount from about 50 to about 98 percent by weight, and, for example, from about 65 to about 95 percent by weight of the toner. The amorphous resin may be a branched or linear amorphous polyester resin. The amorphous resin may possess, for example, a number average molecular weight (Mn), as measured by gel permeation chromatography (GPC), of from about 10,000 to about 500,000, and for example from about 5,000 to about 250,000; a weight average molecular weight (Mw) of, for example, from about 20,000 to about 600,000, and for example from about 7,000 to about 300,000, as determined by GPC using polystyrene standards; and wherein the molecular weight distribution (Mw/Mn) is, for example, from about 1.5 to about 6, and more specifically, from about 2 to about 4.

In ebmodiments, the toner disclosed herein is substantially free of crystalline resins. In other words, the process of making the toner disclosed herein does not include a latex gerentated from or including a crystalline resin. “Substantially free” of crystalline resins refers to a toner having from about 0 weight percent to about 5 weight percent crystalline resin, such as from about 0.01 weight percent to about 4 weight percent or from about 0.05 weight percent to about 3 weight percent crystalline resin.

In embodiments, the process of making particles from the high acid number amorphous polyester involves first generating an emulsion of the high acid number polyester. The emulsion of polyester resin may be generated by dispersing the resin in an aqueous medium by any suitable means. As explained above the emulsion of polyester resin is substantially free of crystalline resins.

As one example, the emulsion may be formed by dissolving the high acid number polyester resin in an organic solvent, neutralizing the acid groups with an alkali base, dispersing with a mixer in water followed by heating to remove the organic solvent, thereby resulting in a latex emulsion. Desirably, the emulsion includes seed particulates of the polyester having an average size of, for example, from about 10 to about 500 nm, such as from about 10 nm to about 400 nm or from about 250 nm to about 250 nm.

In embodiments, the polyester resin may thus be dissolved in the organic solvent and neutralized with an alkali base, heated to 60° C. and homogenized at 2000 rpm to 4000 rpm for 30 minutes, followed by distillation to remove the organic solvent.

Any suitable organic solvent may be used to dissolve the polyester resin, for example, including alcohols, esters, ethers, ketones and amines, such as ethyl acetate in an amount of, for example, about 1% to about 25%, such as about 10% resin to solvent weight ratio.

The acid groups of the polyester resin may be neutralized with an alkali base. Suitable alkali bases include, for example, sodium hydroxide, potassium hydroxide, lithium hydroxide, ammonium hydroxide, sodium bicarbonate, sodium carbonate, lithium carbonate, lithium bicarbonate, potassium bicarbonate and potassium carbonate. The alkali base is used in an amount to fully neutralize the acid. Complete neutralization is accomplished by measuring the pH of the emulsion, for example, pH of about 7.

In embodiments, the at least one high acid number polyester resin can thus be emulsified in water without surfactant, for example by utilizing an alkali base such as sodium hydroxide. The carboxylic acid groups of the polyester are ionized to the sodium (or other metal ion) salt and self stabilize when prepared by a solvent flash process.

The use of a polyester resin synthesized with high acid numbers, for example synthesized with a high carboxylic acid number, thus creates enough ionic stabilization from the resin that nanometer size resin emulsions can be prepared by base neutralization, for example from about pH 6.5 to 7.5, such as about 6.5 to 7, with high shear homogenization without the need for surfactants for stabilization.

In embodiments, the process includes adding to the emulsion a colorant dispersion, for example of about 4% to about 10% by weight of toner, and optionally a wax dispersion, for example from about 6% to about 9% by weight of toner, and shearing with a homogenizer.

Once the emulsion is formed, aggregation may commence. It is optimal to avoid or minimize the use of coagulants for aggregation. Coagulants can introduce metal ions to the toner that cause a decrease in charge maintainability and toner resistivity of the toner. Thus, the aggregation may be conducted by adjusting the pH of the mixture, although the use of coagulants is not excluded herein.

In embodiments, pH adjustment is accomplished by adding an aqueous solution of acid. Suitable aqueous solution of acid include any acid with a pH less than about 5.5, such as sulfuric acid, phosphoric acid, citric acid, nitric acid or an organic soluble acid, in an amount of for example from about 0.01 to 1 molar with homogenization at 4000 to 6000 rpm, until the pH of the mixture is, for example, from about 3 to about 4. Thus, an initial aggregate of the size for example from about 1 to about 3 microns is generated by the pH adjustment.

In embodiments, the process further involves raising the temperature to about 40° C. to 50° C. to allow for particle growth to about 5 to about 7 microns, followed by raising the pH for example to a range of about 6.3 to about 9, with a base such as sodium hydroxide, to prevent further growth, and heating the mixture, for example to about 60° C. to about 95° C., for coalescence of the aggregate and then optionally decreasing the pH, for example to a range of from about 6 to about 6.8, to further enable coalescence of the particles.

For example, polyester ultra low melt emulsion aggregation toner particles can be prepared from emulsions with or without the use of alkali metal coagulants and with or without the use of surfactants within a pH range of from about 3 to about 8, and such as from about 4 to about 7. Drastic pH changes during the process, especially, for example, from pHs less than about 3 and/or higher than about 8, may promote polyester resin hydrolysis in water, creating unwanted oligomers and ionic byproducts.

In embodiments, the process for making the toner without surfactants and/or coagulants thus involves forming a latex by generating an emulsion of a polyester resin having an acid value of from about 13 mg/eq. KOH to about 40 mg/eq. KOH, dissolving the polyester resin in an organic solvent, neutralizing the acid groups with an alkali base, dispersing in water followed by heating to remove the organic solvent, and optionally adding to the emulsion a colorant dispersion and/or a wax dispersion, shearing and adding an aqueous solution of acid until the pH of the mixture is from about 3 to about 5.5, heating to a temperature of from about 30° C. to 60° C., wherein the aggregate grows to a size of from about 3 to about 20 microns, raising the pH of the mixture to a range of about 7 to about 9, heating the mixture to about 60° C. to about 95° C., and optionally decreasing the pH to a range of 6.0 to 6.8. Raising the pH to about 7 to about 9 halts farther growth of the particles.

It is optimal to avoid or minimize the use of surfactants and coagulants that decrease toner resistivity and charge maintainability. The addition of a surfactant and/or coagulant is thus optional.

In embodiments, the process involves optionally adding a surfactant to the emulsion in an amount of, for example, about 0.5 percent to about 5 percent, such as about 1 percent by weight of the toner, heating to temperature of from about 30° C. to 60° C. and wherein the aggregate composite grows to a size of from about 3 to about 20 microns, such as from about 3 to about 11 microns.

Suitable surfactants may include anionic, cationic and nonionic surfactants.

Anionic surfactants can include, for example, sodium dodecylsulfate (SDS), sodium dodecylbenzene sulfonate, sodium dodecylnaphthalene sulfate, dialkyl benzenealkyl, sulfates and sulfonates, adipic acid, available from Aldrich, NEOGEN RK™, NEOGEN SC™ from Kao, and the like.

Examples of cationic surfactants can include dialkyl benzene alkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecyl benzyl triethyl ammonium chloride, MIRAPOL and ALKAQUAT available from Alkaril Chemical Company, SANISOL (benzalkonium chloride), available from Kao Chemicals, and the like. An example of a preferred cationic surfactant is SANISOL B-50 available from Kao Corp., which comprises primarily benzyl dimethyl alkonium chloride.

Examples of nonionic surfactants may include, for example, polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxypoly(ethyleneoxy)ethanol, available from Rhodia as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™.

Examples of additional surfactants, which may be added optionally to the aggregate suspension prior to or during the coalescence to, for example, prevent the aggregates from growing in size, or for stabilizing the aggregate size with increasing temperature can be selected from anionic surfactants such as sodium dodecylbenzene sulfonate, sodium dodecylnaphthalene sulfate, dialkyl benzenealkyl, sulfates and sulfonates, adipic acid, available from Aldrich, NEOGEN R™. NEOGEN SC™ available from Daiichi Kogyo Seiyaku, and the like, among others.

In embodiments, the process may use a coagulant in an amount from about 0.1 to about 2 percent by weight of the toner, such as 0.1 to 1 percent by weight of the toner.

When using a coagulant, the process for making the toner involves generating an emulsion of polyester resin by dissolving the resin in an organic solvent, neutralizing the acid groups with an alkali base, dispersing with a mixer in water followed by heating to remove the organic solvent, thereby resulting in a latex, adding thereto a pigment dispersion for example from about 4% to about 25% by weight of toner, optionally a wax dispersion for example from about 5% to about 25% by weight of toner, and optionally a surfactant for example from about 0.1% to about 3% by weight of toner, and shearing with a homogenizer and adding an aqueous solution of acid, such as nitric acid, from about 0.01 to about 1 molar, until the pH of the mixture is, for example, from about 2.5 to about 4, followed by adding an aqueous solution of coagulant during homogenization and thereby generating an initial aggregate composite with a size for example of from about 1 to about 3 microns, heating to a temperature of from about 30° C. to about 60° C. and wherein the aggregate composite grows to a size for example of from about 3 to about 20 microns, such as from about 3 to about 11 microns, raising the pH of the mixture to a range of for example from about 6.5 to about 9 and heating the mixture to for example from about 60° C. to about 95° C. and optionally decreasing the PH to a range of for example from about 6.0 to about 6.8.

In embodiments, the coagulant may be an inorganic coaguant. Inorganic cationic coagulants include, for example, poly-aluminum chloride (PAC), poly-aluminum sulfosilicate (PASS), aluminum sulfate, zinc sulfate, magnesium sulfate, chlorides of magnesium, calcium, zinc, beryllium, aluminum, sodium, other metal halides including monovalant and divalent halides. The coagulant may be present in an emulsion in an amount of from, for example, from about 0 to about 10 percent by weight, or from about 0.05 to about 5 percent by weight of total solids in the toner. The coagulant may also contain minor amounts of other components, for example nitric acid.

In embodiments, polyaluminum chloride (PAC) is used as a coagulant. A sequestering agent may optionally be introduced to sequester or extract a metal complexing ion such as aluminum or sodium from the coagulant during the EA process.

The final metal ion content in the toner may be in the range of about 25 ppm to about 500 ppm, more specifically from about 100 to about 400 ppm or from about 100 to about 300 ppm. In desired embodiments, the final metal ion content may be less than 150 ppm.

In embodiments, a sequestering agent may be introduced after aggregation is complete to sequester or extract a metal complexing ion such as aluminum from the coagulant during the EA process.

In embodiments, the sequestering or complexing component used after aggregation is complete may comprise an organic complexing component selected from the group consisting of ethylenediaminetetraacetic acid (EDTA), gluconal, sodium gluconate, potassium citrate, sodium citrate, nitrotriacetate salt, humic acid, and fulvic acid; salts of ethylenediaminetetraacetic acid, gluconal, sodium gluconate, potassium citrate, sodium citrate, nitrotriacetate salt, humic acid, and fulvic acid, alkali metal salts of ethylenediaminetetraacetic acid, gluconal, sodium gluconate, potassium citrate, sodium citrate, nitrotriacetate salt, humic acid, and fulvic acid; sodium salts of ethylenediaminetetraacetic acid, gluconal, sodium gluconate, tartaric acid, gluconic acid, oxalic acid, polyacrylates, sugar acrylates, citric acid, potassium citrate, sodium citrate, nitrotriacetate salt, humic acid, and fulvic acid; potassium salts of ethylenediaminetetraacetic acid, gluconal, sodium gluconate, potassium citrate, sodium citrate, nitrotriacetate salt, humic acid, and fulvic acid; and calcium salts of ethylenediaminetetraacetic acid, gluconal, sodium gluconate, potassium citrate, sodium citrate, nitrotriacetate salt, humic acid, fulvic acid, calcium disodium ethylenediaminetetraacetate dehydrate, diammoniumethylenediaminetetraacetic acid, pentasodium diethylenetriaminepentaacetic acid sodium salt, trisodium N-(hydroxyethyl)-ethylenediaminetriacetate, polyasparic acid, diethylenetriamine pentaacetate, 3-hydroxy-4-pyridinone, dopamine, eucalyptus, iminodisuccinic acid, ethylelediaminedisuccinate, polysaccharide, sodium ethylenedinitrilotetraacetate, nitrilo triacetic acid sodium salt, thiamine pyrophosphate, farnesyl pyrophosphate, 2-aminoethylpyrophosphate, hydroxyl ethylidene-1,1-diphosphonic acid, aminotrimethylenephosphonic acid, diethylene triaminepentamethylene phosphonic acid, ethylenediamine tetramethylene phosphonic acid, and mixtures thereof.

Toner particles may contain a colorant. Any desired or effective colorant can be employed, including pigment, dye, mixtures of pigment and dye, mixtures of pigments, mixtures of dyes, and the like, may be included in the toner.

Examples of suitable colorants for making toners include carbon black such as REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™M, MCX6369™; Bayer magnetites BAYFERROX 8600™, 8610™; Northern Pigments magnetites, NP-604™, NP-608™; Magnox magnetites TMB-110™, or TMB-104™; and the like. As colored pigments, there can be selected, for example, various known cyan, magenta, yellow, red, green, brown, blue colorants or mixtures thereof. Specific examples of pigments include phthalocyanine HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido)phthalocyanine, x-copper phthalocyanine pigment listed in the Color Index as CI 74160, CI Pigment Blue, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CL Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan, magenta, yellow components may also be selected as pigments. The colorants, such as pigments, selected can be flushed pigments as indicated herein. Colorant examples further include Pigment Blue 15:3 having a Color Index Constitution Number of 74160, Magenta Pigment Red 81:3 having a Color Index Constitution Number of 45160:3, and Yellow 17 having a Color Index Constitution Number of 21105, and known dyes such as food dyes, yellow, blue, green, red, magenta dyes, and the like.

Additional useful colorants include pigments in water based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RHD 9365X and 9504X (Pigment Red 57 15850:1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YHD 600X and 9604X (Pigment Yellow 14 21095), FLEXIVERSE LFD 4343 and LFD 9736 (Pigment Black 7 77226) and the like or mixtures thereof. Other useful water based colorant dispersions commercially available from Clariant include HOSTAFINE Yellow GR, HOSTAFINE Black T and Black TS, HOSTAFINE Blue B2G, HOSTAFINE Rubine F6B and magenta dry pigment such as Toner Magenta 6BVP2213 and Toner Magenta E02, which can be dispersed in water and/or surfactant prior to use.

In embodiments, the colorant, for example carbon black, cyan, magenta anchor yellow colorant, may be incorporated in an amount sufficient to impart the desired color to the toner. In general, pigment or dye, may be employed in an amount ranging from about 2% to about 35% by weight of the toner particles on a solids basis, more specifically, from about 5% to about 25% by weight or from about 5% to about 15% by weight. In embodiments, more than one colorant may be present in the toner particles. For example, two colorants may be present in the toner particles, such as a first colorant of pigment blue that may be present in an amount ranging from about 2% to about 10% by weight of the toner particles on a solids basis, more specifically, from about 3% to about 8% by weight or from about 5% to about 10% by weight, with a second colorant of pigment yellow that may be present in an amount ranging from about 5% to about 20% by weight of the toner particles on a solids basis, more specifically from about 6% to about 15% by weight or from about 10% to about 20% by weight.

The toner may also contain a wax. The wax may be present in an amount of from about 5% to about 25% by weight of the particles. Examples of suitable waxes include polypropylenes and polyethylenes commercially available from Allied Chemical and Petrolite Corporation, wax emulsions available from Michaelman Inc. and the Daniels Products Company, EPOLENE N-15™ commercially available from Eastman Chemical Products, Inc., VISCOL 550-P™, a low weight average molecular weight polypropylene available from Sanyo Kasei K.K., and similar materials. The commercially available polyethylenes selected usually possess a molecular weight of from about 1,000 to about 1,500, while the commercially available polypropylenes utilized for the toner compositions of the present invention are believed to have a molecular weight of from about 4,000 to about 5,000. Examples of suitable functionalized waxes include, for example, amines, amides, imides, esters, quaternary amines, carboxylic acids or acrylic polymer emulsion, for example JONCRYL™ 74, 89, 130, 537, and 538, all available from SC Johnson Wax, chlorinated polypropylenes and polyethylenes commercially available from Allied Chemical and Petrolite Corporation and SC Johnson wax.

In embodiments, external additives may be used in the toner. For example, toner particles may be blended with an external additive package using a blender such as a Henschel blender. External additives are additives that associate with the surface of the toner particles. In embodiments, the external additive package may include one or more of silicon dioxide or silica (SiO₂), titania or titanium dioxide (TiO₂), and cerium oxide. Silica may be a first silica and a second silica. The first silica may have an average primary particle size, measured in diameter, in the range of, for example, from about 5 nm to about 50 nm, such as from about 5 nm to about 25 nm or from about 20 nm to about 40 nm. The second silica may have an average primary particle size, measured in diameter, in the range of, for example, from about 100 nm to about 200 nm, such as from about 100 nm to about 150 nm or from about 125 nm to about 145 nm. The second silica external additive particles have a larger average size (diameter) than the first silica. The titania may heave an average primary particle size in the range of, for example, about 5 nm to about 50 nm , such as from about 5 nm to about 20 nm or from about 10 nm to about 50 nm. The cerium oxide may have an average primary particle size in the range of, for example, about 5 nm to about 50 nm, such as from about 5 nm to about 20 nm or from about 10 nm to about 50 nm.

Zinc stearate may also be used as an external additive. Calcium stearate and magnesium stearate may provide similar functions. Zinc stearate may have an average primary particle size in the range of, for example, about 500 nm to about 700 nm, such as from about 500 nm to about 600 nm or from about 550 nm to about 650 nm.

It is desirable that toners and developers be functional under a broad range of environmental conditions to enable good image quality from a printer. Thus, it is desirable for toners and developers to function well in each of low humidity and low temperature, for example at 10° C. and 15% relative humidity (denoted herein as C-zone), moderate humidity and temperature, for example at 21° C. and 50% relative humidity (denoted herein as B-zone), and high humidity and temperature, for example at 28° C. and 85% relative humidity (denoted herein as A-zone).

For good performance under a broad range of conditions, properties of the toner should change as little as possible across the above environmental zones described as A-zone, B-zone and C-zone. A valuable toner attribute is thus the relative humidity sensitivity ratio, that is, the ability of a toner to exhibit similar charging behavior at different environmental conditions such as high humidity or low humidity. If there is a large difference across these zones, the materials may have a large relative humidity (RH) sensitivity ratio, which means that the toner may show performance shortfalls in the extreme zones, either at low temperature and humidity, or high temperature and humidity, or both. In embodiments, a RH sensitivity ratio may be expressed as a ratio of a triboelectric charge of the toner developer in the C-zone to a triboelectric charge of the toner developer in A-zone. A goal is for the RH sensitivity ratio to be as close to one as possible. When such an RH sensitivity ratio is achieved, the toner may be equally effective in both high humidity and low humidity conditions. Stated another way, the toner has low sensitivity to changes in RH. In embodiments, the RH sensitivity ratio may be in the range from about 1 to about 2, for example from about 1.1 to about 1.7 or from about 1.1 to about 1.5.

In embodiments, the toner particles disclosed herein may have a triboelectric charge of from about 10 μC/g to about 80 μC/g, such as from about 15 μC/g to about 70 μC/g or from about 20 μC/g to about 60 μC/g, in both the A-zone and the C-zone. Triboelectric charge may be obtained by placing about 0.5 gram of toner in a glass jar containing about 10 grams of the carrier, for example Xerox Workcentre Pro C3545 carrier. The jar with toner and carrier is then conditioned under the desired environmental conditions, such as A-zone, B-zone or C-zone, overnight. The jar is placed on a Turbula mixer and shaken for about 60 minutes. Triboelectric charge of the developer may then be obtained by the total blow-off method at 55 psi air pressure.

The toner particles disclosed herein provide improved toner cohesion, improved gloss and improved crease properties.

Toner cohesion may be measured using a Hosokawa Micron PT-R tester, available from Micron Powders Systems. Toner cohesion is typically expressed in percent (%) cohesion. Percent cohesion may be measured by placing a known mass of toner, for example 2 grams, on top of a set of stacked screens, for example a top screen that has 53 micron mesh or openings, a middle screen that has 45 micron mesh or openings, and a bottom screen that has 38 micron mesh or openings, and vibrating the screens and toner for a fixed time at a fixed vibration amplitude, for example for 90 seconds at 1 millimeter vibration amplitude. All screens are made of stainless steel. In embodiments, the percent cohesion is calculated as follows:

% cohesion=50·A+30·B+10·C

where A is the mass of toner remaining on the 53 micron screen, B is the mass of toner remaining on the 45 micron screen, and C is the mass of toner remaining on the 38 micron screen. The percent cohesion of the toner is related to the amount of toner remaining on each of the screens at the end of the time. A percent cohesion value of 100% corresponds to all the toner remaining on the top screen at the end of the vibration step and a percent cohesion of 0% corresponds to all of the toner passing through all three screens, in other words, no toner remaining on any of the three screens at the end of the vibration step.

The greater the toner cohesion for toners, the less the toner particles are able to flow. Thus, toner particles exhibiting a lower toner cohesion also exhibit better flow, which in turn improves clogging performance in a xerographic device.

In embodiments, the toner cohesion measured near room temperature, from about 22° C. to about 26° C., may be from about 0 percent to about 30 percent, such as from about 0 percent to about 25 percent or from about 0 percent to about 20 percent. Desirably, the toner cohesion is less than about 15 percent or less than about 10 percent. In comparison, current known toners, such as the Xerox Workcentre Pro C3545 toner available from Fuji Xerox exhibit acceptable toner qualities, but may exhibit a toner cohesion of from about 40 percent to about 50 percent.

Toner blocking can be determined by measuring the toner cohesion at elevated temperature above room temperature. Toner blocking measurement is completed as follows: two grams of additive toner is weighed into an open dish and conditioned in an environmental chamber at the specified elevated temperature and 50% relative humidity. After about 17 hours the samples are removed and acclimated in ambient conditions for about 30 minutes. Each re-acclimated sample is measured by sieving through a stack of two pre-weighed mesh sieves, which are stacked as follows: 1000 μm on top and 106 μm on bottom. The sieves are vibrated for about 90 seconds at about 1 mm amplitude with a Hosokawa flow tester. After the vibration is completed the sieves are reweighed and toner blocking is calculated from the total amount of toner remaining on both sieves as a percentage of the starting weight. Thus, for a 2 gram toner sample, if A is the weight of toner left the top 1000 μm screen and B is the weight of toner left the bottom 106 μm screen, the toner blocking percentage is calculated by:

% blocking=50 (A+B)

In embodiments, the % blocking at 55° C. may be from about 0 percent to about 20 percent, such as from about 0 percent to about 15 percent or from about 0 percent to about 10 percent. Desirably, the toner % blocking at 55° C. is less than about 20 percent, such as less than about 10 percent or less than about 5 percent.

The toner described herein may further exhibit improved crease properties. Crease property refers to how well an image avoids cracking when the image is folded or creased, and is generally referred to as a “crease area.”

Crease area, a measure of the degree of permanence of a fused image formed from the toner, may be evaluated by the crease area test in which a fused image is folded under a specific weight (typically a 0.68 kg roller) with the toner image to the inside of the fold. The image is then unfolded, and the crease is wiped with a clean pad using steady pressure, to determine the extent of toner removal in the crease area. Then, three 2.5 cm portions, including the center of the crease and on each side of the center of the crease, are evaluated for toner image separation from the substrate, and a value is assigned, taking into account the amount of paper showing through the crease, the width of the crease, and the existence of fracturing/cracking in the crease, A value of 160 represents nearly complete failure in the crease, whereas a value of 20 represents little damage in the crease area except in the area of the immediate crease. Thus, the greater the separation and/or the greater the extent of fractures/cracking through the toner image, the greater the crease area. A desired crease area is about 80 or less.

The toner described herein further exhibits a high gloss. High gloss refers to, for example, the gloss of a material being greater than about 20 gloss units, such as about 30 gloss units. In embodiments, the toners herein, may exhibit a high gloss of from about 30 to about 90 gloss units (GGU), such as from about 40 to about 80 GGU or from about 45 to about 75 GGU, as measured by the Gardner Gloss metering unit; for example on a coated paper, such as Xerox 120 gsm Digital Coated Gloss papers, or on plain paper such as Xerox 90 gsm Digital Color Xpressions+ paper.

Although the toner may be any type of toner containing a polyester resin an being substantially free of crystalline resin, it must have a resistivity of at least about 1×10¹¹ ohm-cm. The resistivity of the toner may be regulated by a variety factors including, but not limited to the amount of polyester resin in the toner, the amount of sulfonation, the amount of alkali metal present in the toner, and the choice of the alkali metal type. For example, changing the sulphonation level of the amorphous resin changes the resistivity. Generally, addition of a more insulative material to the toner bulk or toner surface can also increase the resistivity of the toner.

The developer compositions disclosed herein can be selected for electrophotographic, especially xerographic, imaging and printing processes, including digital processes. The toners may be used in image development systems employing any type of development scheme without limitation, including, for example, conductive magnetic brush development (CMB), which uses a conductive carrier; insulative magnetic brush development (IMB), which uses an insulated carrier, semiconductive magnetic brush development (SCMB), which uses a semiconductive carrier, etc. Most preferably the developers are used in SCMB development systems.

Illustrative examples of carrier particles that can be selected for mixing with the toner composition prepared in accordance with the present disclosure include those particles that are capable of triboelectrically obtaining a charge of opposite polarity to that of the toner particles. Illustrative examples of suitable carrier particles include granular zircon, granular silicon, glass, steel, nickel, ferrites, magnetites, iron ferrites, silicon dioxide, and the like. Additionally, there can be selected as carrier particles nickel berry carriers as disclosed in U.S. Pat. No. 3,847,604, the entire disclosure of which is hereby totally incorporated herein by reference, comprised of nodular carrier beads of nickel, characterized by surfaces of reoccurring recesses and protrusions thereby providing particles with a relatively large external area. Other carriers are disclosed in U.S. Pat. Nos. 6,764,799, 6,355,391, 4,937,166 and 4,935,326, the disclosures of which are hereby totally incorporated herein by reference.

The selected carrier particles can be used with or without a coating, the coating generally being comprised of fluoropolymers, such as polyvinylidene fluoride resins, terpolymers of styrene, methyl methacrylate, a silane, such as triethoxy silane, tetrafluorethylenes, other known coatings and the like. In embodiments, the carrier coating may comprise polymethyl methacrylate, copoly-trifluoroethyl-methacrylate-methyl methacrylate, polyvinylidene fluoride, polyvinylfluoride copolybutylacrylate methacrylate, copoly perfluorooctylethylmethacrylate methylmethacrylate, polystyrene, or a copolymer of trifluoroethyl-methacrylate and methylmethacrylate containing a sodium dodecyl sulfate surfactant. The coating may include additional additives such as a conductive additive, for example carbon black.

In another embodiment, the carrier core is partially coated with a polymethyl methacrylate (PMMA) polymer having a weight average molecular weight of 300,000 to 350,000 commercially available from Soken. The PMMA is an electropositive polymer in that the polymer that will generally impart a negative charge on the toner with which it is contacted.

The PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like.

In another preferred embodiment herein, the polymer coating of the carrier core is comprised of PMMA, most preferably PMMA applied in dry powder form and having an average particle size of less than 1 micrometer, preferably less than 0.5 micrometers, that is applied (melted and fused) to the carrier core at higher temperatures on the order of 220° C. to 260° C. Temperatures above 260° C. may adversely degrade the PMMA. Triboelectric tunability of the carrier and developers herein is provided by the temperature at which the carrier coating is applied, higher temperatures resulting in higher tribo up to a point beyond which increasing temperature acts to degrade the polymer coating and thus tower tribo.

Carrier cores with a diameter of, for example, about 5 micrometers to about 100 micrometers may be used. More specifically, the carrier cores are, for example, about 20 micrometers to about 60 micrometers. Most specifically, the carriers are, for example, about 30 micrometers to about 50 micrometers. In an especially preferred embodiment, a 35 micrometer ferrite core available from Powdertech of Japan is used. The preferred ferrite core is a proprietary material believed to be a strontium/manganese/magnesium ferrite formulation.

Typically, polymer coating coverage can be, for example, from about 30 percent to about 100 percent of the surface area of the carrier core with about a 0.1 percent to about a 4 percent coating weight. Specifically, about 75 percent to about 98 percent of the surface area is covered with the micropowder by using about a 0.3 percent to about 1.5 percent coating weight. The use of smaller-sized coating powders may be advantageous as a smaller amount by weight of the coating can be selected to sufficiently coat a carrier core. The use of smaller-sized coating powders also enables the formation of thinner coatings. Using less coating is cost effective and results in less coating amount separating from the carrier to interfere with the triboelectric charging characteristics of the toner and/or developer.

If a carrier is included, the carrier must have a resistivity of at least about 1×10⁷ ohm-cm. In one embodiment the resistivity may be regulated by decreasing or increasing the amount of carbon black found in the carrier. By decreasing the concentration of the carbon black in the carrier coating, the resistivity of the carrier is increased. One skilled in the art will recognize other methods of regulating the resistivity of the carrier. Other known methods for increasing resistivity of the carrier include, but are not limited to, reducing the conductivity of the carrier core particle by changing the composition or processing conditions in the formation of the core, increasing the thickness of a resistive coating polymer, increasing the resistivity of the coating polymer, changing the composition of the carbon black or other conductive additive in the carrier, or modifying the dispersion of the carbon black or other conductive additive in the carrier. Examples of conductive additives in the carrier include, but are not limited to, metal oxides, conductive polymers, such as inorganic metallic polymers disclosed in U.S. Pat. No. 6,423,460 and incorporated herein by reference, and conductive metal halides disclosed in U.S. Pat. No. 4,810,611 and incorporated herein by reference.

In an image forming process, an image forming device is used to form a print, typically a copy of an original image. An image forming device imaging member (for example, a photoconductive member) including a photoconductive insulating layer on a conductive layer, is imaged by first uniformly electrostatically charging the surface of the photoconductive insulating layer. The member is then exposed to a pattern of activating electromagnetic radiation, for example light, which selectively dissipates the charge in the illuminated areas of the photoconductive insulating layer while leaving behind an electrostatic latent image in the non-illuminated areas. This electrostatic latent image may then be developed to form a visible image by depositing the toner particles, for example from a developer composition, on the surface of the photoconductive insulating layer.

The resulting visible toner image can be transferred to a suitable image receiving substrate such as paper and the like.

To fix the toner to the image receiving substrate, such as a sheet of paper or transparency, hot roll fixing is commonly used. In this method, the image receiving substrate with the toner image thereon is transported between a heated fuser member and a pressure member with the image face contacting the fuser member. Upon contact with the heated fuser member, the toner melts and adheres to the image receiving medium, forming a fixed image. This fixing system is very advantageous in heat transfer efficiency and is especially suited for high speed electrophotographic processes.

Fixing performance of the toner can be characterized as a function of temperature. The lowest temperature at which the toner adheres to the support medium is referred to as the Cold Offset Temperature (COT), and the maximum temperature at which the toner does not adhere to the fuser member is referred to as the Hot Offset Temperature (HOT). When the fuser temperature exceeds HOT, some of the molten toner adheres to the fuser member during fixing and is transferred to subsequent substrates containing developed images resulting, for example, in blurred images. This undesirable phenomenon is known as offsetting. Between the COT and HOT of the toner is the Minimum Fix Temperature (MFT), which is the minimum temperature at which acceptable adhesion of the toner to the image receiving substrate occurs, as determined by, for example, a creasing test. The difference between MFT and HOT is referred to as the fusing latitude.

The fuser member suitable for use herein comprises at least a substrate and an outer layer. Any suitable substrate can be selected for the fuser member. The fuser member substrate may be a roll, belt, flat surface, sheet, film, drelt (a cross between a drum or a roller), or other suitable shape used in the fixing of thermoplastic toner images to a suitable copy substrate. Typically, the fuser member is a roll made of a hollow cylindrical metal core, such as copper, aluminum, stainless steel, or certain plastic materials chosen to maintain rigidity and structural integrity, as well as being capable of having a polymeric material coated thereon and adhered firmly thereto. The supporting substrate may be a cylindrical sleeve, preferably with an outer fluoropolymeric layer of from about 1 to about 6 millimeters, in one embodiment, the core, which can be an aluminum or steel cylinder, is degreased with a solvent and cleaned with an abrasive cleaner prior to being primed with a primer, such as DOW CORNING® 1200, which can be sprayed, brushed, or dipped, followed by air drying under ambient conditions for thirty minutes and then baked at about 150° C. for about 30 minutes.

Also suitable are quartz and glass substrates. The use of quartz or glass cores in fuser members allows for a lightweight, low cost fuser system member to be produced. Moreover, the glass and quartz help allow for quick warm-up, and are therefore energy efficient. In addition, because the core of the fuser member comprises glass or quartz, there is a real possibility that such fuser members can be recycled. Moreover, these cores allow for high thermal efficiency by providing superior insulation.

When the fuser member is a belt, the substrate can be of any desired or suitable material, including plastics, such as ULTEM®, available from General Electric, ULTRAPEK®, available from BASF, PPS (polyphenylene sulfide) sold under the tradenames FORTRON®, available from Hoechst Celanese, RYTON R-4®, available from Phillips Petroleum, and SUPEC®, available from General Electric; PAI (polyamide imide), sold under the tradename TORLON® 7130, available from Amoco; polyketone (PK), sold under the tradename KADEL® E1230, available from Amoco; PI (polyimide); polyaramide; PEEK (polyether ether ketone), sold under the tradename PEEK 450GL30, available from Victrex; polyphthalamide sold under the tradename AMODEL®, available from Amoco; PES (polyethersulfone); PEI (polyetherimide); PAEK (polyaryletherketone); PBA (polyparabanic acid); silicone resin; and fluorinated resin, such as PTFE (polytetrafluoroethylene); PFA (perfluoroalkoxy); FEP (fluorinated ethylene propylene); liquid crystalline resin (XYDAR®), available from Amoco; and the like, as well as mixtures thereof. These plastics can be filled with glass or other minerals to enhance their mechanical strength without changing their thermal properties. In embodiments, the plastic comprises a high temperature plastic with superior mechanical strength, such as polyphenylene sulfide, polyamide imide, polyimide, polyketone, polyphthalamide, polyether ether ketone, polyethersulfone, and polyetherimide. Suitable materials also include silicone rubbers. Examples of belt-configuration fuser members are disclosed in, for example, U.S. Pat. Nos. 5,487,707 and 5,51.4,436, the disclosures of each of which are totally incorporated herein by reference. A method for manufacturing reinforced seamless belts is disclosed in, for example, U.S. Pat. No. 5,409,557, the disclosure of which is totally incorporated herein by reference.

The fuser member may include an intermediate layer, which can be of any suitable or desired material. For example, the intermediate layer can comprise a silicone rubber of a thickness sufficient to form a conformable layer. Suitable silicone rubbers include room temperature vulcanization (RTV) silicone rubbers, high temperature vulcanization (HTV) silicone rubbers, and low temperature vulcanization (LTV) silicone rubbers. These rubbers are known and are readily available commercially such as SILASTIC® 735 black RTV and SILASTIC® 732 RTV, both available from Dow Coming, and 106 RTV Silicone Rubber and 90 RTV Silicone Rubber, both available from General Electric. Other suitable silicone materials include the silanes, siloxanes (preferably polydimethylsiloxanes), such as fluorosilicones, dimethylsilicones, liquid silicone rubbers, such as vinyl crosslinked heat curable rubbers or silanol room temperature crosslinked materials, and the like. Other materials suitable for the intermediate layer include polyimides and fluoroelastomers. The intermediate layer may have a thickness of from about 0.05 to about 10 millimeters, such from about 0.1 to about 5 millimeters or from about 1 to about 3 millimeters.

The layers of the fuser member can be coated on the fuser member substrate by any desired or suitable means, including normal spraying, dipping, and tumble spraying techniques. A flow coating apparatus as described in U.S. Pat. No. 6,408,753 the disclosure of which is totally incorporated herein by reference, can also be used to flow coat a series of fuser members. In embodiments, the polymers may be diluted with a solvent such as an environmentally friendly solvent, prior to application to the fuser substrate. Alternative methods, however, can be used for coating layers, including methods described in U.S. Pat. No. 6,099,673, the disclosure of which is totally incorporated herein by reference.

The outer layer of the fuser member may comprise a fluoropolymer such as polytetrafluoroethylene (PTFE), fluorinated ethylenepropylene copolymer (FEP), polyfluoroalkoxy (PFA), perfluoroalkoxy polytetrafluoroethylene (PFA TEFLON®), ethylene chlorotrifluoro ethylene (ECTFE), ethylene tetrafluoroethylene (ETFE), polytetrafluoroethylene perfluoromethylvinylether copolymer (MFA), combinations thereof and the like.

In embodiments, the outer layer may further comprise at least one filler. Examples of fillers suitable for use herein include a metal filler, a metal oxide filler, a doped metal oxide filler, a carbon filler, a polymer filler, a ceramic filler, and mixtures thereof.

In embodiments, an optional adhesive layer may be located between the substrate and the intermediate layer. In further embodiments, the optional adhesive layer may be provided between the intermediate layer and the outer layer. The optional adhesive intermediate layer may be selected from, for example, epoxy resins and polysiloxanes.

The subject matter disclosed herein will now be further illustrated by way of the following examples. All parts and percentages are by weight unless otherwise indicated.

### EXAMPLES

### Toner Example 1

The emulsion/aggregation (EA) polyester toner was prepared via a pH process utilizing an emulsion made with the XP777® an amorphous polyester resin, which has a Tg of about 56.9° C. and a Ts of about 108° C. and acid number of about 16.7. The toner had about 4.5 wt % PB15.3 pigment and about 9 wt % Carnauba wax.

### Comparative Toner 1

Comparative Toner 1 was Xerox cyan DC3535 toner obtained from Fuji Xerox.

### Toner Example 1 and Comparative Toner 1 Plus Surface Additives and Carrier

The particle size of Toner Example 1 was about 6.67 microns with a geometric standard deviation (GSD) of about 1.27/1.30, and with a circularity of about 0.956. The sodium content of the final toner was about 206 ppm.

The EA polyester toner was blended with surface additives in an SKM mill for about 30 seconds at about 15 krpm.

Both toners were blended with the same additive formulation. Additives were added in pph relative to the parent toner weight, and were about 1.71 weight percent RY50 silica, about 0.88 weight percent JMT2000 titania plus about 1.73 weight percent X24 sol-gel silica, about 0.55 weight percent cerium oxide plus about 0.2 weight percent ZnSt.

### Carrier

The carrier used with Toner Example 1 and Comparative Toner 1 was Xerox DC 3545 carrier.

### Results

The results of Toner Example 1 and Comparative Toner 1 are as follows:

| | Charge in | | | | | | |
|---|---|---|---|---|---|---|---|
| | Surrogate | | Toner | Blocking | Charge in Xerox | | |
| | Machine (μC/g) | | Cohesion | at 55° C. and | DC 2240 in | Gloss | Crease |
| | A-zone | C-zone | (%) | 50% RH (%) | B-zone (μC/g) | (GGU) | Area |
| Toner Example 1 | −33.5 | −48.9 | 13.6 | 4.9 | −38.1 | 68 | 11.6 |
| Comparative | −22.7 | −44.7 | 46.5 | 100 | −44.5 | 49 | 16.5 |
| Toner 1 | | | | | | | |

It is clear from the results, that Toner Example 1 exhibits improved toner cohesion, charge performance, gloss and crease area properties.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An emulsion aggregation toner comprised of at least one polyester resin,
wherein the toner is substantially free of crystalline resin,
wherein the toner has an acid value of from about 13 mg/eq. KOH to about 40 mg/eq. KOH, and
wherein the toner has a toner cohesion of from about 0% to about 30% at about room temperature.

2. The toner according to claim 1, wherein the polyester resin is a linear amorphous polyester resin or a branched amorphous polyester resin.

3. The toner according to claim 1, comprising at least two polyester resins, wherein the at least two polyester resins are an amorphous polyester resin.

4. The toner according to claim 3, where the amorphous polyester resin is a linear amorphous polyester resin or a branched amorphous polyester resin.

5. The toner according to claim 1, wherein the polyester resin is selected from the group consisting of poly(1,2-propylene-diethylene)terephthalate, polyethylene-terephthalate, polypropylene-terephthalate, polybutylene-terephthalate, polypentylene-terephthalate, polyhexalene-terephthalate, polyheptadene-terephthalate, polyoctalene-terephthalate, polyethylene-sebacate, polypropylene-sebacate, polybutylene-sebacate, polyethylene-adipate, polypropylene-adipate, polybutylene-adipate, polypentylene-adipate, polyhexalene-adipate polyheptadene-adipate, polyoctalene-adipate, polyethylene-glutarate, polypropylene-glutarate, polybutylene-glutarate, polypentylene-glutarate, polyhexalene-glutarate, polyheptadene-glutarate, polyoctalene-glutarate, polyethylene-pimelate, polypropylene-pimelate, polybutylene-pimelate, polypentylene-pimelate, polyhexalene-pimelate, polyheptadene-pimelate, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), or poly(1,2-propylene itaconate), and mixtures thereof.

6. The toner according to claim 1, wherein the toner has a triboelectric charge of from about 10 μC/g to about 80 μC/g.

7. The toner according to claim 1, wherein the toner has a metal ion content of from about 25 ppm to about 500 ppm.

8. The toner according to claim 1, wherein the polyester resin has a glass transition temperature of from about 53° C. to about 70° C., and a softening temperature of from about 90° C. to about 135° C.

9. The toner according to claim 8, wherein the glass transition temperature is from about 56° C. to about 60° C., and the softening temperature is from about 105° C. to about 125° C.

10. The toner according to claim 1, wherein the toner further comprises a colorant, a wax and/or a surface additive.

11. A developer comprising a toner according to claim 1 and optionally a carrier.

12. The developer according to claim 11, wherein a resistivity of the toner is at least 1×10¹¹ ohm-cm, and a resistivity of a carrier is at least 1×10⁷ ohm-cm.

13. The developer according to claim 11, wherein the carrier includes a carrier core selected from the group consisting of granular zircon, granular silicon, glass, steel, nickel, ferrites, iron ferrites and silicon dioxide.

14. The developer according to claim 13, wherein wherein the carrier is coated with a coating selected from the group consisting of polyvinylidene fluoride resins, terpolymers of styrene, methyl methacrylate, a silane, tetrafluorethylenes, polymethyl methacrylate, copoly-trifluoroethyl-methacrylate-methyl methacrylate, polyvinylidene fluoride, polyvinylfluoride copolybutylacrylate methacrylate, copoly perfluorooctylethylmethacrylate methylmethacrylate, polystyrene, or a copolymer of trifluoroethyl-methacrylate and methylmethacrylate containing a sodium dodecyl sulfate surfactant.

15. The developer according to claim 11, wherein the developer is in a semiconductive magnetic brush development system.

16. An image forming device, comprising:
a development system including an emulsion aggregation toner, and
an oil-less fuser member
wherein the emulsion aggregation toner is comprised of a polyester resin, is substantially free of a crystalline resin, and has a toner cohesion of from about 0% to about 30% at about room temperature.

17. The image forming device according to claim 16, wherein the fuser member comprises a substrate as an outer layer comprising a fluoropolymer.

18. The image forming device according to claim 16, wherein the fluoropolymer is selected from the group consisting of polytetrafluoroethylene, fluorinated ethylenepropylene copolymer, polyfluoroalkoxy, perfluoroalkoxy polytetrafluoroethylene, ethylene chlorotrifluoro ethylene, ethylene tetrafluoroethylene, polytetrafluoroethylene perfluoromethylvinylether copolymer, and polymers thereof,

19. The image forming device according to claim, 16, wherein the fuser member further comprises an intermediate layer positioned between the substrate and the outer layer.

20. The image forming device according to claim 19, wherein the intermediate layer comprises silicone rubber.

21. The image forming device according to claim 16, wherein the outer layer further comprises a filler.

22. The image forming device according to claim 21, wherein the filler is selected from the group consisting of a metal filler, a metal oxide filler, a doped metal oxide filler, a carbon filler, a polymer filler, a ceramic filler and mixtures thereof

23. The image forming device according to claim 16, wherein the substrate is a roller or a belt.

24. The image forming device according to claim 16, wherein the development system is a conductive magnetic brush development system.

25. The image forming device according to claim 16, wherein the toner has an acid value of from about 13 mg/eq. KOH to about 40 mg/eq. KOH.

26. A process for forming particles, comprising:
generating an emulsion of a polyester resin having an acid value of from about 13 mg/eq. KOH to about 40 mg/eq. KOH, and
generating aggregate particles from the emulsion,
wherein the emulsion is substantially free of a crystalline resin.

27. The process according to claim 26, further comprising a colorant to the emulsion.

28. The process according to claim 26,
wherein the generating an emulsion comprises dissolving the polyester resin in an organic solvent, neutralizing the acid groups with an alkali base, and dispersing in water followed by heating to remove the organic solvent, thereby resulting in a latex,
wherein the process further comprises optionally adding to the emulsion a colorant dispersion and/or a wax dispersion,
wherein the generating the aggregate particles comprises shearing and adding an aqueous solution of acid until the pH of the mixture is from about 3 to about 5.5, heating to a temperature of from about 30° C. to about 60° C., wherein the aggregate grows to a size of from about 3 to about 20 microns, raising the pH of the mixture to a range of about 7 to about 9, heating the mixture to about 60° C. to about 95° C., and optionally decreasing the pH to a range of about 6 to about 6.8.

29. The process according to claim 26, wherein the generating the emulsion comprises omitting any surfactant in the emulsion, and the generating the aggregate particles comprises omitting addition of coagulants.

30. The process according to claim 26, wherein the polyester resin is a linear amorphous polyester resin or a branched amorphous polyester resin.

31. The process according to claim 26, further comprising adding the coagulant, wherein the coagulant is an aluminum sulfate, a polyaluminum chloride, a cationic surfactant, an alkali halide, an alkali acetate, or a water soluble metal salt with valency of about 2 or more, or combinations thereof.

32. The process according to claim 26, wherein the particles have a metal ion content of from about 25 ppm to about 500 ppm.
